(19) United States
(12) Patent Application Publication
(10) Pub. No.: US 2008/0147486 A1
(43) Pub. Date: Jun. 19, 2008

(54) PREDICTION METHOD AND SYSTEM

(75) Inventor: S. David Wu, Bethlehem, PA (US)

Correspondence Address: RATNERPRESTIA, P O BOX 980, VALLEY FORGE, PA, 19482-0980, US

(73) Assignee: Lehigh University, Bethlehem, PA (US)

(21) Appl. No.: 11/958,964

(22) Filed: Dec. 18, 2007

Related U.S. Application Data
(60) Provisional application No. 60/875,440, filed on Dec. 18, 2006.

(51) Int. Cl. G06Q 10/00

(52) U.S. Cl. 705/10; 705/7

(57) ABSTRACT

A method and apparatus for predicting future data values based on past data values. Past data values such as past product demand values are received. Leading indicators are identified based on the past data values. The future data values are generated based on the leading indicators.

### FIELD

This pertains to forecasting and, more particularly, to using leading indicators for forecasting.

### BACKGROUND OF THE INVENTION

In the mid to late 1990's, high-tech industries such as consumer electronics, telecommunications equipment, and semiconductors were experiencing unprecedented growth and expansion. During that time, many firms developed and deployed supply chain management systems to integrate and optimize their operations. With goals of reducing costs and cycle times, companies focused on internal integration but continued to rely on a traditional model of demand planning in which marketing adjusts the projections of customers to produce a unit forecast against which operations executes.

Against the backdrop of rapid demand growth fueled by the dot corn boom, planning to customer-driven marketing forecasts was adequate, because companies were more concerned with keeping pace with demand and ensuring availability of products than with the accuracy of the data being provided by customers. However, this approach to planning prohibited many companies from reacting more quickly to the industry decline when it began in 2001. With the decline initially predicted to be short-lived, many customers were reluctant or slow to revise their forecasts. Many suppliers were reluctant or unable to enforce penalties for order cancellations and were left in the difficult position of trying to reconcile optimistic forecasts with increasingly negative economic indicators. By the time the industry acknowledged the depth and potential duration of the decline, many companies were left to assume financial responsibility for large buffers of inventory and underutilized capital equipment, further depleting already limited cash reserves.

Even in good economic times, the demand for high-tech products is volatile and challenging to manage; the rapid rate of innovation causes short product lifecycles, while long production lead times hamper a firm's ability to respond. Uncertain economic times, however, increase the challenge significantly. Whereas in an environment of sustained demand growth, supply chain partners might build inventory or hold excess capacity to buffer against demand variability, many are reluctant or unable to assume such financial risk in a slowing market. Firms recognize, however, that they must provide both innovative products and exceptional service in order to retain their customer base and to gain new revenue opportunities. To do so, they must structure their supply chains to respond to upside demand and to absorb downside risks without creating excessive inventory or capacity. It is for this reason that the high-tech industry as a whole has gone through a profound transformation during the past decade, starting with growth and expansion in the mid 1990's and continuing through contraction in the early 2000's.

As part of this transformation, major corporations are focusing on those aspects of the product realization process where they hold the strongest value proposition instead of owning and operating the entire process. Many are moving aggressively away from vertically integrated operations to horizontally integrated operations that involve multiple contract manufacturers. In such a restructured supply chain, a customer may subcontract its manufacturing to multiple contract manufacturers with each subcontractor placing orders on the component suppliers. By consolidating demands across multiple customers and developing and investing in highly flexible processes, contract manufacturers are able to achieve high utilization on their equipment, thereby reducing unit costs.

The shortening product lifecycle and the emergence of contract manufacturing reflect broader trends in the global economy toward rapid product innovation cycles and increasingly complex manufacturing and supply chain partnerships. High-tech contract manufacturers in particular have a significant presence in the Asia-Pacific region. They represent a dominating force and a significant economic driver for China, Taiwan, Korea, and Malaysia. In addition, major ports such as Hong Kong and Singapore have become logistics consolidation points for many of these operations as well as a major sources of investment capital.

### SUMMARY

A method of identifying leading indicators based on a received plurality of data streams. A cluster of the plurality of the received data streams is selected. The strength of a plurality of data streams of the cluster relative to at least a portion of the plurality of received data streams is determined. At least one of the data streams having a strength exceeding a threshold value as a leading indicator is selected.

A method of generating a prediction based on a received plurality of data streams. The strength of one or more of the plurality of data streams is determined. The one or more data streams having a strength greater than a threshold value are identified as a leading indicator. Predicted values for the plurality of data streams are generated based on the at least one of the one or more data streams identified as a leading indicator.

A method of generating a prediction based on a received plurality of data streams. A correlation between each of the plurality of data streams and the other of the plurality of data streams is computed. Data streams are selected responsive to the strength of their respective computed correlation. Predicted values for at least one of the plurality of data streams are generated based on the selected data streams.

A computerized system for generating a prediction. The system includes a computerized database stored on a computer memory medium. A processor in communication with the database is configured to control the system to receiving a plurality of data streams, determine a strength of one or more of the plurality of data streams, identify at least one of the one or more data streams having a strength greater than a threshold value as a leading indicator, and generate predicted values for the plurality of data streams based on the at least one of the one or more data streams identified as a leading indicator.

### BRIEF DESCRIPTION OF THE DRAWINGS

FIG. 1 is a histogram showing the deviation percentage between average order board quantity and actual shipment quantity over a fourteen month period;

FIGS. 2A and 2B are plots showing examples of demand leading indicators according to an exemplary embodiment of the invention;

FIG. 3A is a flow chart illustrating an method according to an exemplary embodiment of the invention;

FIG. 3B is a block diagram of a system according to an exemplary embodiment of the invention;

FIG. 4 is a plot showing the 11-month forecasting performance of leading indicators against time lag and absolute value of correlation according to an exemplary embodiment of the invention;

FIGS. 5A-C are plots showing forecasting performance of leading indicators identified for 3 different estimation and validation periods for a cluster of 643 products according to an exemplary embodiment of the invention;

FIGS. 6A-B are plots showing forecasting performance of two leading indicators identified for a sub-cluster of 120 products according to an exemplary embodiment of the invention;

FIG. 7 is a plot showing monthly shipment quantities of a product over multiple generations and overlapping life-cycles according to an exemplary embodiment of the invention;

FIG. 8 is a plot showing monthly shipment quantities of a composite product (CP) versus a cluster according to an exemplary embodiment of the invention;

FIG. 9A is a plot showing predicted demand growth without a leading indicator; and

FIG. 9B is a plot showing predicted demand growth with a leading indicator according to an exemplary embodiment of the invention.

### DETAILED DESCRIPTION

Features of exemplary embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

An exemplary method and apparatus are described below for predicting future data values based on patterns and relationships established from past data values. Past data values, such as product demand quantities, are received and analyzed. The method identifies “leading indicators”—data items that are shown to predict the pattern of a larger data set. The method shows that a leading indicator's pattern-predicting property is sustained in future data. The method monitors the unfolding of the leading indicator data over time, thereby making statistical influences of the future patterns of the larger data set. For instance, the method could predict a surge in demand volume several months ahead of time, or predict highly volatile or stable demand patterns for the months to come.

The operations of a semiconductor manufacturing company typically consist of two main stages. In the “front-end” operation, silicon wafers are fabricated in clean room facilities (fabs), and in the “back-end” operation, wafers are cut, packaged into IC chips, and tested. The front-end operation involves a manufacturing lead time of six to twelve weeks and typically is the bottleneck, while the back-end operation requires two to four days. Many semiconductor manufacturers outsource the front-end operation and become “fabless” because the wafer fabs are capital intensive and require significant lead time to build. A typical fab costs $1 billion to $4 billion and 12 to 18 months to build. Although a semiconductor manufacturer may retain a portion of its fab capabilities in house, a substantial portion of the front-end operation is handled by foundry partners such as Chartered Semiconductor and TSMC (Taiwan Semiconductor Manufacturing Company). The back-end operations are typically performed other facilities in Asia.

The high-tech manufacturing environment is primarily driven by time-based competition, where a manufacturer's ability to provide responsive and flexible supply to a customer defines its competitive advantage. Demand characterization tools that will allow a manufacturer to handle demand signals proactively such that capacity can be aligned for the right time at the right level are known as supply-demand planning tools. In the context of a global supply chain, high-tech companies can only survive when they have a keen understanding of their demands. Specifically, when there is a shift in demand volume, they need to be able to react quickly and adjust the allocation of capacity in their supply chain. The method and system described herein may have significant implications to a company's ability to anticipate demand changes and assess their potential impacts.

### Understanding High-Tech Demand Volatility

The compressed technology lifecycle and the increasingly complex supply structure (due to contract manufacturing) of high-tech manufacturing firms have stretched existing supply-demand planning systems to the limit. To understand the extent of this phenomenon as experienced by planners and decision makers alike, we examined the demand information available to the decision makers via a sophisticated order management system. For each product, the order management system tracks the orders placed by a customer for a shipment in an upcoming week; these orders are referred to as the backlog or the order board. Because customers may make adjustments to the order quantity between the time the order is placed and the time the order is shipped, the snapshot as of February 28 of the order board for shipments anticipated in the week of March 14 to 18 may differ from the snapshot as of March 7. To understand the volatility of the demand, we reconstructed from historical data weekly views of the order board over a 14-month period between 2001 and 2002 for a representative sample of products in telecommunications, personal computing and storage.

For each shipment that occurred for each product, we reconstructed the sequence of weekly views of the order quantities associated with that shipment and computed the mean value of the order quantities. Then we compared the mean value to the actual shipment quantity and computed the percentage of deviation, defined as the difference between the mean value and the actual quantity divided by the actual quantity.

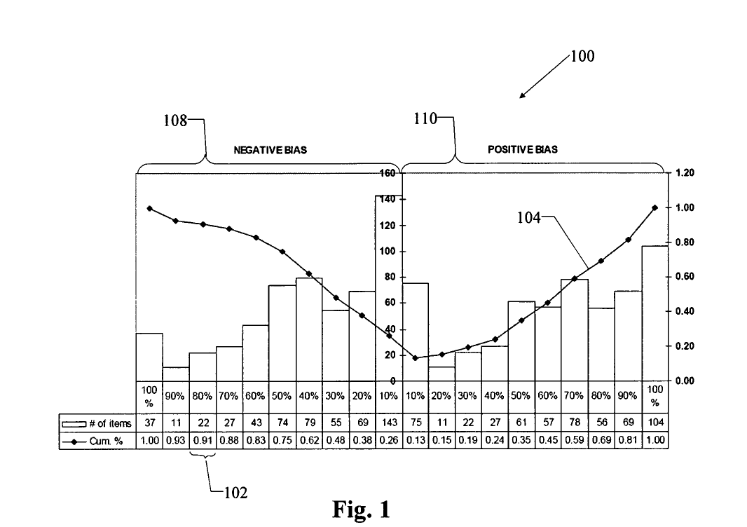

The histogram 100 in FIG. 1 summarizes the results of the analysis for 560 products over the 14-month period. For each percentage range (e.g., 102), the histogram 100 shows the number of products whose percentage of deviation falls in that range. The line 104 plots the cumulative percentage of products whose percentage of deviation falls below a particular value. The left half 108 of the histogram 100 represents the case of a “negative” deviation where the actual shipment is lower than the mean backlog quantity. The right half 110 of the histogram 100 represents “positive” deviation where the actual shipment is higher than the mean backlog quantity. Positive bias arises when the shipment during a particular week includes new orders that arrived in the time between the last snapshot of the order board and the shipment date; some of the new orders may actually be orders that were originally booked for a later shipment date.

The percentage of deviation and the number of occurrences are alarmingly high, possibly resulting from a highly volatile market for which even order board data is a poor indicator of actual shipments. The order management system also stores the demand forecast, which is generated by the marketing department and is updated monthly. If we reconstruct the sequence of monthly views of the forecasted order quantities and compare the mean forecasted value to the actual shipment quantity, it is not surprising that the deviation is significantly greater than the deviation from the order board data illustrated in FIG. 1.

In many high-tech manufacturing environments, operations managers have resigned themselves to the fact that demand is too volatile to forecast. A common belief is that timely information updates, reduced lead times, and well-controlled operations would enable production to be driven completely by orders from the order board. However, as illustrated in FIG. 1, even the order board data may be highly unreliable. For the purpose of long-term planning, we need a comprehensive and in-depth characterization of demand, despite the inherit difficulty in constructing one. For specialized semiconductors, there are significant technological barriers to reducing production lead time, and there is no meaningful way to build finished goods inventory, since most IC chips are customized for special functionality. Therefore, capacity planning plays a crucial role in combating demand uncertainty both for in-house capacity expansion and outsourced capacity negotiation and capacity reservation.

Time series forecasting methods (on which most commercial forecasting systems are based) generally are not appropriate for high-tech products such as semiconductor and telecommunications. Technology products tend to have short product lifecycles as a result of continued innovations, and the data available early in the lifecycle typically are insufficient for time series analysis. Traditional time series forecasting methods are designed for situations where the demand trend is stable or cyclic. This is not characteristic of high-tech products, whose demand can vary tremendously going through the different stages of its lifecycle. Time series forecasting methods that rely on a product's historical demands to predict future demands do not yield satisfactory results.

### The Leading Indicator Analysis

The exemplary method described below first determines if any discernable patterns can be derived from historical demand data. More specifically, we try to determine if there exist certain demand “leading indicators” that provide advanced warning of major demand changes. After performing statistical analysis on historical shipment data, we found that when we divide products into product groups, or clusters, we are able to detect (in each cluster) a subset of “leading indicator” products that provide advanced indication of changes in demand patterns of the entire cluster.

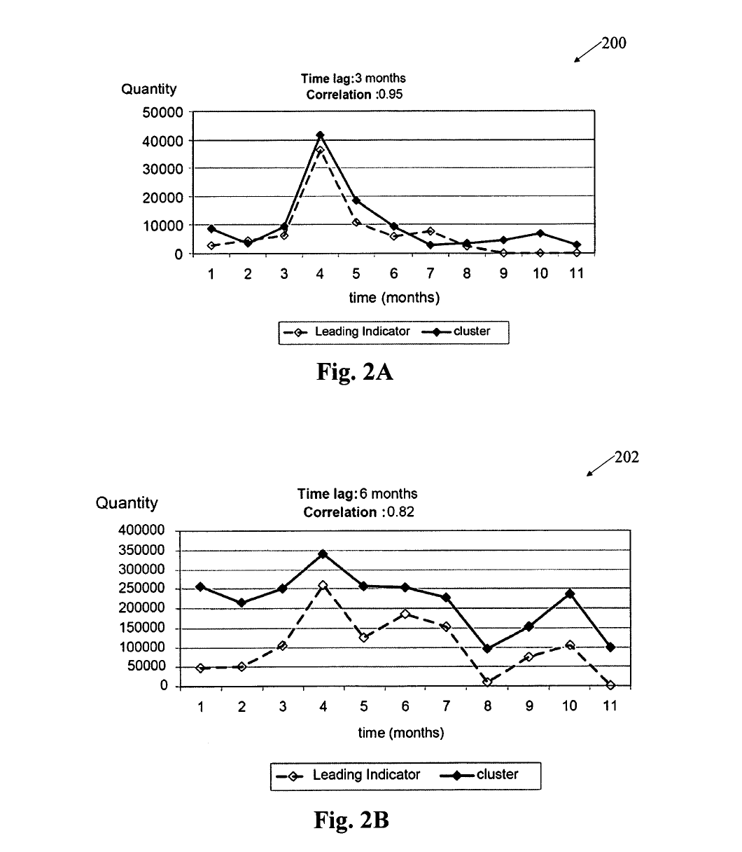

A leading indicator of a product group can be characterized by the correlation of its demand pattern in relation to the group and the time lag by which the demand pattern leads the rest of the group. There is a trade-off between the two. For example, the chart 200 in FIG. 2A shows a leading indicator that predicts the demand pattern of a larger group three months ahead of time with a correlation of 0.95. The chart 202 in FIG. 2B shows a six-month time lag with a correlation of 0.82. In both examples, the leading indicator's demand is less than 2% of the total demand of the products in the cluster and is excluded from the cluster demand calculation. The exclusion prevents a product from been identified as a leading indicator simply because of its large volume.

Technology lifecycles for high-tech products follow a general demand cycle that starts with an initial growth (ramp up) followed by a period of stability and then a decline in sales when a new generation of products is introduced. The lifecycle of a product is driven in part by technological innovation as well as market competition. One reason that the traditional time series forecasting approach is ineffective for high-tech products is due to the short technological lifecycle demonstrated by these products; there is no reason to believe that the demand trend demonstrated in historical data is going to continue in the future. The premise behind the leading indicator analysis is that there exists a subset of products (i.e., the leading indicators) that capture the lifecycle effect of a larger product group.

### The Leading Indicator Search Procedure

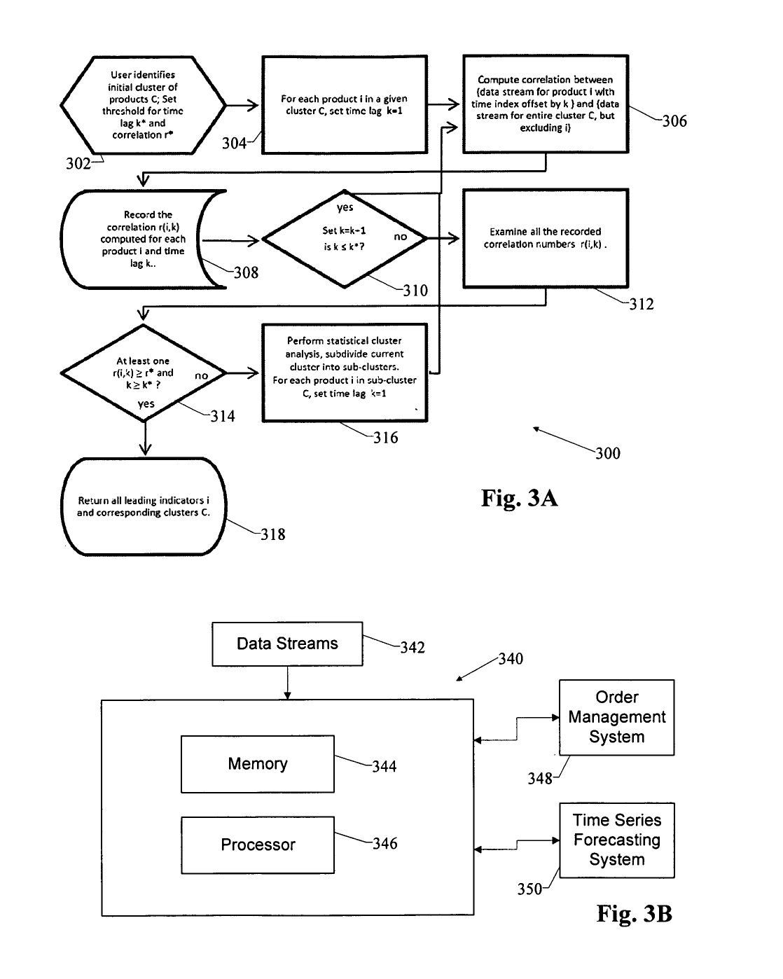

Described below is the analysis procedure of a leading indicator method according to an exemplary embodiment of the invention. In an exemplary embodiment, the method is performed using a spreadsheet-based “leading indicator engine” implementation. The exemplary engine is created such that it is convenient to test demand data provided by any semiconductor manufacturer so long they provide their data in a standardized format. A description of this exemplary implementation is described below with reference to the flow chart 300 in FIG. 3A.

1. The user identifies a product group of interest and sets a threshold specifying the minimum time lag and correlation required in step 302. To initialize the procedure, in an exemplary embodiment all products in the group are placed into one common cluster.

2. Finding Leading Indicators. Within each cluster, we find all of the leading indicators above the required threshold as follows:

(a) Initialization. Given a cluster C of products, select a product i from the cluster and set time lag k=1 in step 304.

(b) Main Step. Compute the correlation in step 306 between (i) the demand time series associated with product i where the time series is offset by (t−k) and (ii) the demand time series associated with the cluster excluding i (set C\{i}).

(c) Record the correlation r(i, k) computed for each product i and time lag k in step 308.

(d) Set k=k+1. Repeat the Main Step 306 and record 308 the correlation number ρᵢₖ computed for each product i with time lag k.

(e) Repeat steps 306-310 (b-d above) for each product iεC.

3. Examine all the correlation numbers ρᵢₖ computed in step 312. Determine in step 314 whether at least one of the correlation ρᵢₖ and its corresponding time lag k satisfy the specified threshold. If yes, proceed to step 318 (step 4 below). Otherwise, perform re-clustering in step 316 as follows according to an exemplary embodiment:

(a) Re-clustering. Using statistical cluster analysis, subdivide the product group into clusters based on statistical patterns demonstrated by each product's historical demand; a variety of attributes may be used for clustering, e.g., mean shipment quantity, shipment frequency, volatility, skewness, etc.

(b) Repeat steps 306-314 (steps 2 and 3 above) for each cluster.

4. Return the leading indicator(s) and the corresponding product cluster(s) in step 318.

An important result from our analysis is that given a product group of interest, the leading indicator engine can often find one or more indicator(s) that predicts the group demand pattern two to eight months ahead of time with a correlation ranging from 0.51 to 0.95. More importantly, these leading indicators are capable of producing reliable forecasts for the larger product group.

There is shown in FIG. 3B an system 340 for generating leading indicators and for generating forecasts based on such leading indicators according to an exemplary embodiment of the invention. The system 340 includes a memory 344 and a processor 346. The system 340 receives data streams 342 used for identifying leading indicators. The system 340 generates forecasts using such leading indicators which may be provided to another system for application of such forecast such as an order management system 348, for example. The system may also use a leading indicator forecast to supplement or adjust a forecast generated by a time series forecasting system 350, for example.

### EXAMPLES

The leading indicator engine analyzes the data associated with a specified group of products, systematically searches for a set of leading indicator products for the group and generates demand forecasts based on the leading indicator identified. The tool also can be used in a scenario analysis mode to test whether a particular product is a strong leading indicator for some group of products, which is a question of great managerial interest. In this section, we provide several examples to illustrate different aspects of the leading indicator analysis. Our experiments were conducted using monthly demand data that covered the 26-month period from December 2001 to January 2004. The data set included 3,500 semiconductor (IC) products across eight business entities. For testing purposes, we used an estimation-validation procedure as follows. We designate, for example, the first 15 months in the data set as the estimation period (EP), which represents the historical demand data visible to the forecasting system. We reserve the remaining 11 months as the validation period (VP), which represents the “actual” demand after a forecast is generated. The VP allows us to measure the forecast error by comparing the forecast against the actual. The forecast error in an exemplary embodiment may be calculated using mean absolute percentage error or MAPE. An exemplary procedure is described below.

### The Estimation-Validation Procedure

In the experiments, the 26-month data set is split into an estimation period (EP) and a validation period (VP). Let [1,T] be the time period (in months) for which the shipment data is available, and let the subperiod [t₀,t₁] be the EP in which the leading indicators are identified and the parameters for the forecast are determined. The remaining time period [t₁+1,T] is used as the VP over which the forecasting performance of a candidate leading indicator is tested. As such, any h-month forecast can be validated by the data set by comparing the forecast to actual shipment and hε[1,T−t₁].

### Measuring Forecast Error using Available Shipment Data

Throughout the experiments, the mean absolute percentage error (MAPE) is calculated as follows:

$$MAPE ( ξ ) = \frac{1}{ξ} {\sum }_{i = 1}^{ξ} \frac{\vert yi - \hat{y} i \vert}{yi}$$

where yᵢ is the actual shipment quantity during period i and ŷᵢ is the shipment quantity estimated by the trend line during period i. During the estimation period (EP), a trend line is first generated to fit the data, and MAPE measures how well a particular trend line fits the data. During the validation period (VP), MAPE measures how well the trend line predicts the demand, i.e., MAPE measures forecast error as a percentage of the actual (shipment) quantity.

### The Coefficient of Correlation

Over the estimation period [t₀,t₁], the degree of the linear relationship between the time series of cluster C and product i at time lag k is quantified in an exemplary embodiment by using the following correlation coefficient:

$${ρ}_{ik} = \frac{{\sum }_{t = {t}_{0} + k}^{{t}_{1}} ( {x}_{i , t - k} - \overline{x} ) ( {y}_{t} - \overline{y} )}{{\sqrt{{\sum }_{t = {t}_{0} + k}^{{t}_{1}} ( {x}_{i , t - k} -} \overline{x} )}^{2} {\sum }_{t = {t}_{0} + k}^{{t}_{1}} {( {y}_{t} - \overline{y} )}^{2}}$$

where x_{i,t} and yₜ denote the actual shipment quantities of a candidate leading indicator i and the rest of the cluster in month t, and x̅ᵢ and y̅ are the average shipment quantities over the corresponding time horizons in which correlation is calculated. Thus, the correlation coefficient ρᵢₖ measures how well the demand of item i over time period [t₀,t₁−k] predicts the demand of the cluster over [t₀+k, t₁]. Although described above with regard to a linear relationship, exemplary embodiments of the invention encompass determining a degree of non-linear relationship between the time series of cluster C and product i at time lag k.

Note that the correlation coefficient is determined by comparing the time series of the item against that of the rest of the cluster. The total shipment quantity of the cluster is adjusted in an exemplary embodiment by removing the item's quantity from each month's shipment quantity. In this way, the bias that might be introduced from a (high-volume) dominating item is eliminated.

### The Leading Indicator Based Forecast

After a leading indicator i is identified from a cluster C based on time lag k and coefficient of correlation ρᵢₖ, we construct a forecast for cluster C based on the time series of the leading indicator using the following exemplary procedure.

1. Regress the time series of cluster C over the EP [t₀+k, t₁] against the time series of the leading indicator over [t₀,t₁−k]. Determine the corresponding regression parameters \hat{β}₀ and \hat{β}₁.

2. For a given month t, generate the forecast for the cluster, \tilde{y}ₜ, using k-month earlier time series data of leading indicator i as follows:

\tilde{y}ₜ=\hat{β}₀+\hat{β}₁x_{i,t-k}

3. Calculate the forecast error for leading indicator i over the VP [t₁+1,T]: for an h-month forecast during the VP, calculate MAPE(h) based on (1) above.

4. Calculate the overall fitting error over the estimation period [t₀,t₁+h]: calculate MAPE(m) for m=t₁₊ₕ−t₀.

The first step in the process of identifying leading indicators is to specify a set of products. In this section, we describe an exemplary embodiment of the invention with regard to a group of 643 products within one particular business entity.

To begin, we are interested in finding leading indicators for the one cluster of 643 products, and we allow any product within the cluster to be a candidate leading indicator. We perform the leading indicator analysis over three different time horizons in order to gain insight into how the length of the time horizon and the age of the historical data affect which leading indicators are selected.

For the first time horizon, we consider an EP covering months 1 through 15 and a VP covering months 16 through 26. Using the leading indicator analysis, we evaluate each of the 643 products for different time lag values from one to seven months. We calculate the correlation between the product's demand series (offset by the time lag) and the cluster's demand (excluding the product under consideration). We then rank all of the product-time lag pairs by their absolute correlation over the EP. For the top 100 product-time lag pairs (leading indicators), we produce a leading indicator-based forecast for months 16 through 26 using the procedure described above, and we compute the forecasting error (in MAPE) using the actual shipment data from the VP.

Table 1 summarizes the one-month and the 11-month forecasting performance of the top 100 leading indicators, all of which have a correlation value above 0.6. In the table, we show the distribution of indicators according to MAPE value and time lag. For example, the entry with value 26 in the row labeled “0-20%” and the column with time lag “6 or 7” indicates that of the 61 leading indicators with time lags of 6 or 7 months, 26 of them have a one-month forecast MAPE in the range of 00% to 20%. The results in Table 1 suggest that there exists a strong pool of leading indicators for products in this business entity. From Table 1, we see that there are 34 products with MAPE values of at most 20% for the one-month forecast and 28 products with MAPE values of at most 40% for the 11-month forecast.

TABLE 1
Distribution of Top 100 Leading Indicators by Time Lag and
by 1-Month and 11-Month Forecast Error (MAPE)

| | Time Lag | | | 1-Month | Time Lag | | | 11-Month |
|---|---|---|---|---|---|---|---|---|
| MAPE | 1, 2 or 3 | 4 or 5 | 6 or 7 | Total | 1, 2 or 3 | 4 or 5 | 6 or 7 | Total |
| 0-20% | 5 | 3 | 26 | 34 | 0 | 0 | 0 | 0 |
| 20-40% | 6 | 2 | 2 | 10 | 4 | 2 | 22 | 28 |
| 40-60% | 1 | 9 | 9 | 19 | 4 | 5 | 8 | 17 |
| 60-80% | 1 | 2 | 7 | 10 | 3 | 7 | 3 | 13 |
| 80-100% | 0 | 1 | 9 | 10 | 2 | 5 | 11 | 18 |
| >100% | 1 | 8 | 8 | 17 | 1 | 6 | 17 | 24 |
| Total: | 14 | 25 | 61 | 100 | 14 | 25 | 61 | 100 |

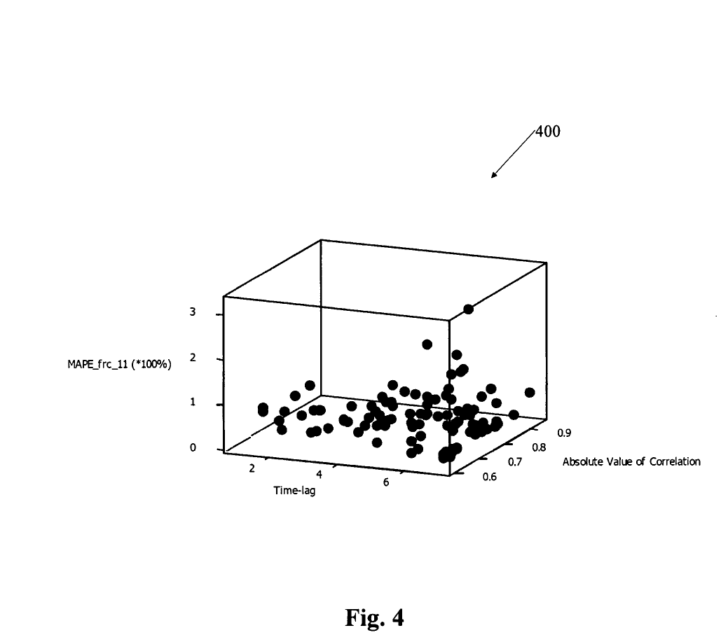

As an alternative view of the pool of leading indicators, FIG. 4 shows a plot 400 of the 11-month forecasting performance of the top 100 leading indicators against time lag and absolute value of correlation. The plot 400 reveals that a large number of leading indicators have time lags longer than four months, suggesting that they are capable of providing warnings for demand changes sufficiently far in advance. Notice however that some of the products with the longer time lags perform well in forecasting whereas others perform poorly. One reason why products with the longer time lags may perform poorly is that fewer data points are available for the correlation analysis after the data has been shifted to account for the time lag. FIG. 4 also reveals that a strong correlation value alone is not a sufficient measure in determining a leading indicator; there are several instances in which products with relatively low absolute correlation values have relatively good forecasting performance.

As new information becomes available over time, the correlation value and the forecasting performance of a leading indicator are likely to change. Therefore, we need mechanisms by which we update a previously selected leading indicator product and determine the amount of historical data to be used. To gain insight into the issue of updating, we performed the leading indicator analysis for a second time horizon; we consider an EP covering months 1 through 20 and a VP covering months 21 through 26. Then, we compared the set of leading indicator products identified using this EP to those identified for the EP of months 1 through 15. Of the top 100 leading indicators previously identified, 40 of them appear on the list of the top 50 leading indicators for the new EP. This result indicates that the set of 100 candidate leading indicators includes both leading indicators that remain strong with the new information and leading indicators that are misleading and should be disregarded.

To gain insight into the issue of the amount of historical data to use, we performed the leading indicator analysis for a third time horizon using an EP of months 6 through 20 and a VP of months 21 through 26. We compared the set of leading indicators identified to those for the second EP. Of the top 50 leading indicators that were identified for the second EP (months 1 through 20), 25 of them appear on the list of the top 50 leading indicator products for the third EP (months 6 through 20). Therefore, we cannot conclude that more recent data leads to better performance of the leading indicator. Using the longer estimation period (months 1 through 20) requires more data but identifies leading indicators that perform well over a longer time horizon. Using the shorter estimation period allows for the possibility that products with an initial period of poor performance but with a high predictive value with respect to the more recent data are likely to be identified as candidate leading indicators.

### Developing Leading Indicator Forecasts

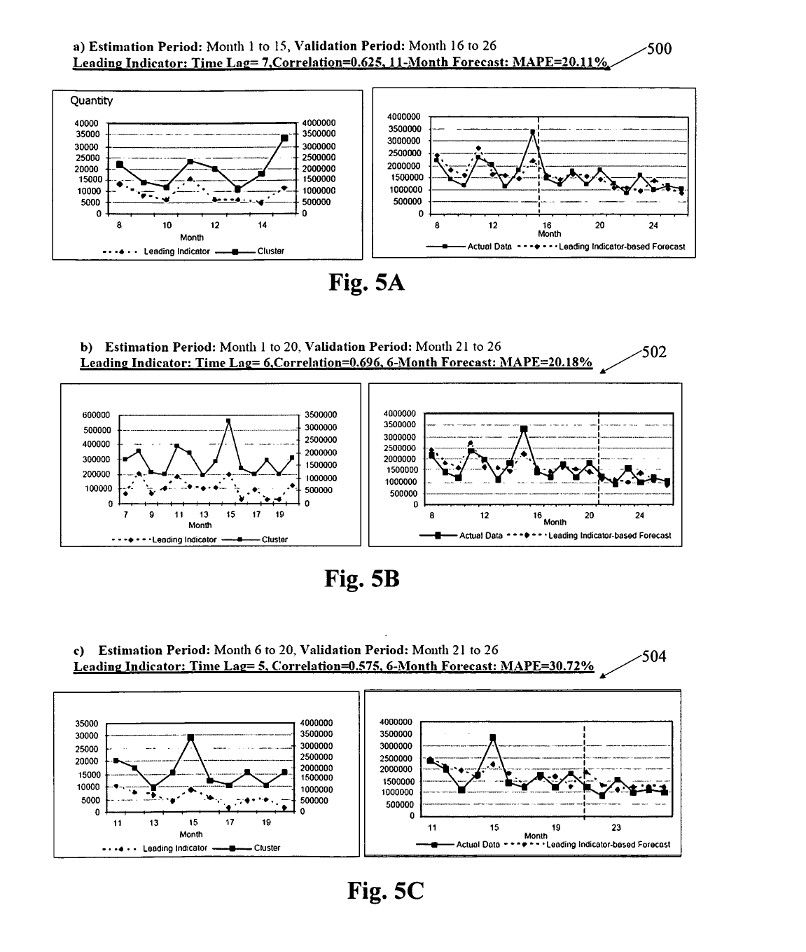

Once we have identified leading indicators, we use them to develop demand forecasts for the product group. FIGS. 5A-C illustrate the forecast performance of three leading indicators, each corresponding to one of the three cases of EP and VP specified above. Each chart on the left in FIGS. 5A-C shows the actual data of the selected leading indicator product with the data of the rest of the cluster over the given EP. In the figure, the dashed line shows the time series data of the leading indicator product as measured by the scale given on the left axis. The solid line shows the time series data of the cluster as measured by the scale given on the right axis. Note that the time series of the cluster is shifted ahead by the appropriate time lag so that the chart shows the mapping between the demand pattern of the indicator product and the cluster. Each chart on the right shows the actual demand of the cluster (solid line) plotted against the forecast (dashed line) generated from the leading indicator product. The vertical line separates the EP from the VP.

The first pair of charts 500 in FIG. 5A illustrates the performance of a leading indicator for an EP from months 1 through 15. This leading indicator provides a signal for the demand pattern of the cluster seven months ahead of time with a correlation of 0.625. The forecast that was generated from a regression model fit within the EP results in a 20.11% MAPE over the 11-month VP. The second pair of charts 502 in FIG. 5B show a leading indicator for an EP of months 1 through 20. This leading indicator predicts the demand pattern of the cluster six months ahead of time with a correlation of 0.696. The leading indicator forecast results in a 20.18% MAPE over a six-month VP. Similarly, the third pair of charts 504 in FIG. 5C illustrates a leading indicator generated from an EP from months 6 through 20, which predicts the cluster demand pattern five months ahead of time with a correlation of 0.575. The leading indicator forecast results in a 30.72% MAPE over an VP of six months.

The analysis according to an exemplary embodiment of the invention of a subset of the 643 products that use a particular wafer fab process is described below. Because future demands for this particular subset of products will have direct implications on the capacity required of this wafer fab, we would like to know how demand will evolve. We allow any of the 120 products within the subset to be a candidate leading indicator, and we perform the leading indicator analysis for an EP of months 1 through 20 and a VP of months 21 through 26.

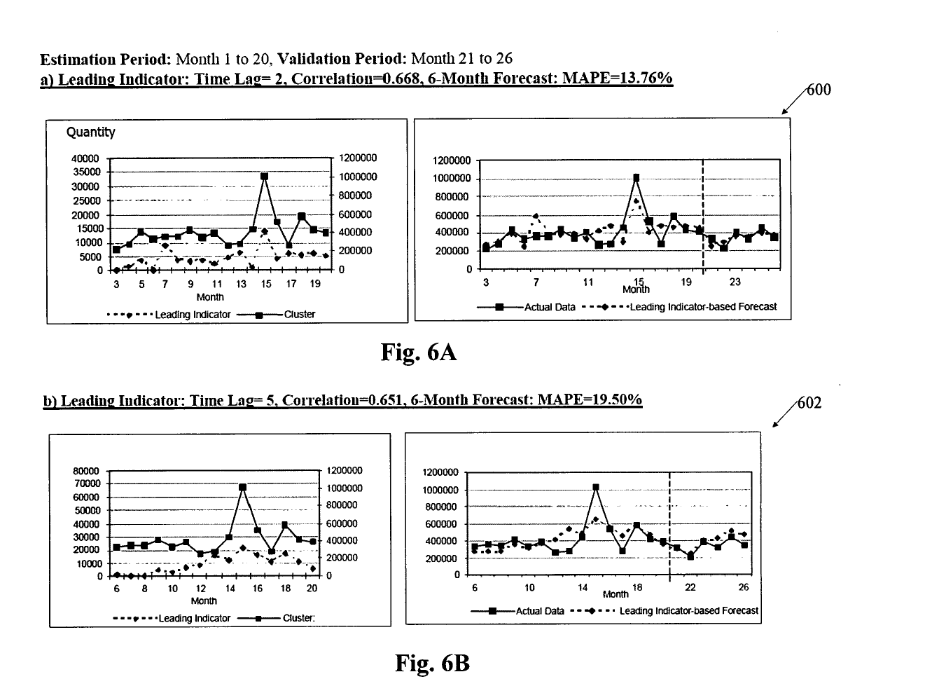

For this smaller cluster, the leading indicator analysis yields ten candidate leading indicators with absolute correlation values above 0.5. The average MAPE value for these candidates is 25% for the one-month forecast horizon and 40% for the six-month forecast horizon. In FIG. 6A, the charts 600 show the results for the product with the highest absolution correlation value (0.668), which provides a signal for the demand pattern of the cluster two months ahead of time. This candidate leading indicator predicts the demand pattern of the cluster during the six-month VP with a small MAPE of 13.76%. The charts 602 in FIG. 6B show the results for another product that exhibits similar performance to the first with respect to the subcluster. However, while the first leading indicator also appears among the top 50 indicators with respect to the entire cluster, the second indicator does not. This result seems to contradict the belief of some managers that there are only a small number of leading indicator products that drive the demand for all product groups of similar characteristics. There is no reason to believe that a strong leading indicator for a subgroup is necessarily going to be a good indicator for the wider group.

We are interested to find out if seasonality plays a role in the leading indicator analysis. We first verify the presence of seasonality in the above data set using Fisher's Kappa test and Barlett's Kolmogorov-Smirnov test as described by Fuller (1996). The latter compares the normalized cumulative periodogram with the cumulative distribution function of the uniform (0,1) to test the null hypothesis that the series is white noise (Miller, 1956). The test also allows for small sample sizes (<100). With 95% confidence, we could not reject the null hypothesis, i.e., the data set does not demonstrate seasonality. The issue of seasonality will be further explored in an example described further below where we detect seasonality using the same test in a different data set. Managers may want to keep track of a high-volume, revenue-driving product of an important customer and know if this product is in fact a leading indicator for a group of related products. For this purpose, we designed the leading indicator engine to be able to test whether a particular product is in fact a strong leading indicator for a specified set of products. Because of the generally short product lifecycles, we would like to be able to consider composites of successive generations of one particular technology as possible candidates for a leading indicator. To handle this situation, in an exemplary embodiment we create a composite product to represent the progression of the technology over time.

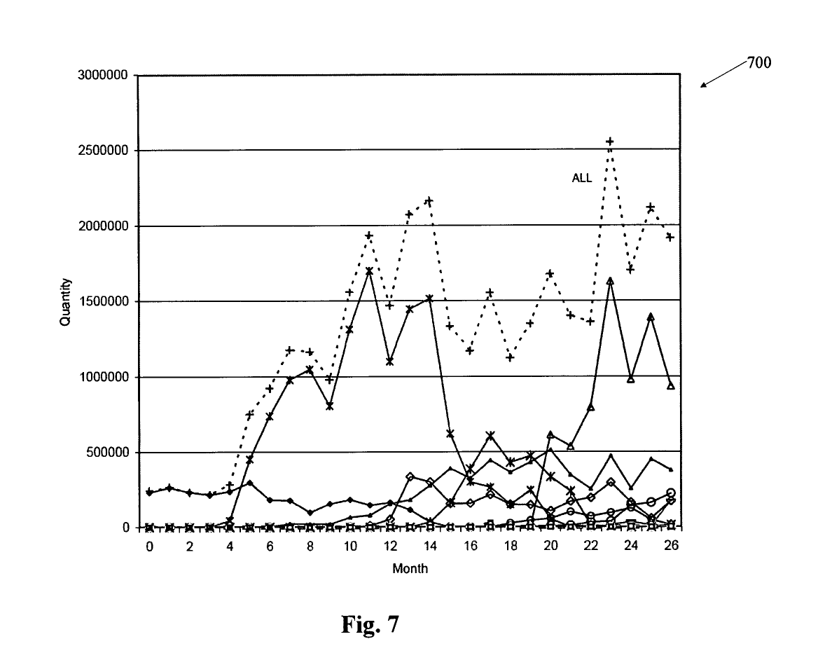

In this subsection, we consider an exemplary composite product made up of 12 products that belong to a business entity that includes short lifecycle products. The 12 products account for about 15% of the total volume of the products within the business entity over the 26-month time horizon. FIG. 7 shows a plot 700 of the time series data associated with these products. The dotted line in FIG. 7 shows the total volume of the 12 products, while the individual curves show a rather complex pattern of technology migration over the 26-month period.

In the remainder of this section, we present the results of two analyses performed according to exemplary embodiments of the invention. First, we analyze whether the composite of the 12 products (consisting of multiple technology generations and modifications) is a strong leading indicator for other products in the same business entity. Second, we determine if the composite product can serve as an indicator for other products (in the same business entity) that also share the same fab capacity. Note that since the composite product accounts for a large portion of the overall volume of the cluster, we perform the analysis in two ways—both including and excluding the leading indicator products from the cluster.

To determine whether the 12-product composite is a leading indicator for the other products in the business entity, we perform the leading indicator analysis over two different time horizons, both of which start after the initial transient phase of the progression. The first time horizon has an EP of months 9 through 24 and the second has an EP of months 14 through 24. In both cases, we use the last two months, 25 and 26, as the VP.

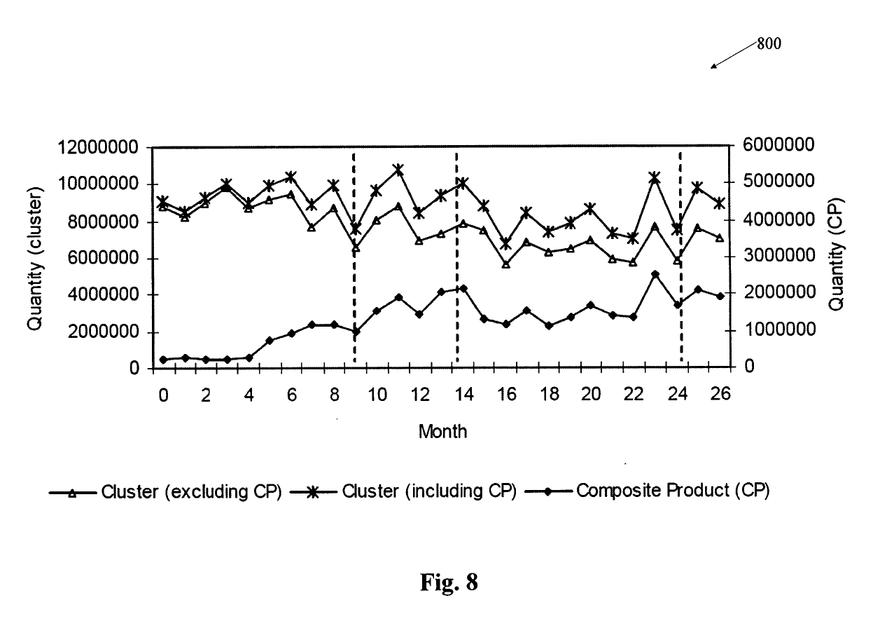

FIG. 8 shows the actual shipment data 800 for the composite product (CP) and for the cluster both excluding the CP and including the CP. Table 2 below shows the forecasting performance of the composite product as a leading indicator for the two time horizons. Here a time lag of zero has been considered to compare the concurrent similarity of the demand pattern of the composite leading indicator to the demand pattern of the cluster. The similarity in the two patterns can be seen both in FIG. 8 and in the results in Table 2. Note that we show the MAPE for both the EP and the VP; the former represents fitting errors between the time series of the leading indicator (CP) and the cluster and the latter represents forecast errors. For time lags greater than zero, the results indicate that the forecast errors for the VP are generally low. In other words, the composite product is indeed a strong leading indicator for the cluster.

TABLE 2
Forecasting Performance (MAPE %) of Composite
Product as a Leading Indicator

| | MAPE | MAPE | MAPE | MAPE | MAPE | MAPE |
|---|---|---|---|---|---|---|
| Time | EP: 9-24 | VP: 25 | VP: 25, 26 | EP: 14-24 | VP: 25 | VP: 25, 26 |
| lag | (%) | (%) | (%) | (%) | (%) | (%) |
| 0 | 8.25 | 7.39 | 2.42 | 7.42 | 3.83 | 2.20 |
| 1 | 11.51 | 9.25 | 6.01 | 9.44 | 14.99 | 11.87 |
| 2 | 11.33 | 20.19 | 12.31 | 7.29 | 31.79 | 22.33 |
| 3 | 9.78 | 13.01 | 7.70 | 6.99 | 16.68 | 13.70 |
| 4 | 10.62 | 12.20 | 8.46 | 8.23 | 15.11 | 11.37 |
| 5 | 9.75 | 15.11 | 9.59 | 10.43 | 16.52 | 12.16 |
| 6 | 8.88 | 15.73 | 11.17 | 6.96 | 17.69 | 10.88 |
| 7 | 8.92 | 16.26 | 12.68 | 10.32 | 10.66 | 8.72 |

Next, we are interested in determining whether the CP is a leading indicator for just the products in the business entity that share the same fab capacity as the CP. Seven of the 12 products in the CP require the same fab process and thus share the capacity. To keep the example simple, we restrict our attention to these seven and create a modified CP, which we call CP2. Within the business entity, there are 74 products that share the same fab capacity with CP2 and the products in CP2 constitute approximately 22% of the total volume. The shipment data corresponding to the composite CP2 appear only in months 14 through 26. Therefore, we perform the leading indicator analysis over a 13-month time horizon with an EP of months 14 to 24 and an VP of months 25 and 26. Since large time lag values result in a small number of data points for the correlation calculations, we restrict the time lags to values from one through four to avoid misleading correlation values. Table 3 shows the forecasting performance of the composites CP2 and CP as leading indicators. The results shown for CP2 correspond to the analysis when the time series data of the cluster excludes CP2. We obtain similar results when the time series data of the cluster includes the leading indicator products.

As shown in the table, CP2 performs very well as a leading indicator for the subcluster with respect to the correlation values and the MAPE values. We are able only to examine time lags up to four months though due to data availability. This example shows that if we select a correct leading indicator, we will be able to use this leading indicator to provide the advanced demand signal needed for capacity planning. We should point out, however, that identifying a leading indicator does not happen by accident. For instance, as shown in Table 3, the original composite product CP performs rather poorly as the leading indicator for this cluster.

TABLE 3
Forecasting Performance (MAPE %) of CP2 and CP as Leading Indicators for Cluster of
74 Products Sharing Same Fab Process

| | | MAPE | MAPE | MAPE | | MAPE | MAPE | MAPE |
|---|---|---|---|---|---|---|---|---|
| | CP2 | EP: 14-24 | VP: 25 | VP: 25, 26 | CP | EP: 14-24 | VP: 25 | VP: 25, 26 |
| Time lag | Correlation | (%) | (%) | (%) | Correlation | (%) | (%) | (%) |
| 0 | 0.9192 | 9.51 | 11.42 | 10.93 | 0.5721 | 20.80 | 26.91 | 25.53 |
| 1 | 0.7023 | 16.57 | 22.65 | 13.92 | 0.0338 | 25.54 | 37.93 | 34.25 |
| 2 | 0.8882 | 10.20 | 20.74 | 14.68 | −0.3582 | 21.08 | 57.32 | 45.73 |
| 3 | 0.9186 | 7.21 | 15.46 | 24.83 | 0.0253 | 18.52 | 32.42 | 28.00 |
| 4 | 0.5434 | 12.85 | 19.19 | 14.43 | −0.5053 | 13.94 | 28.42 | 24.03 |

### The Effect of Seasonality

The data set used in the above experiments belongs to a family of mass storage devices that have a relatively more stable and potentially cyclic market demand. Below, we explain the roll of seasonality in the leading indicator analysis. Using Barlett's Kolmogorov-Smirnov test as described earlier and with 95% confidence, the presence of seasonality is detected. Upon inspection, we have determined that the seasonality repeats in a quarterly fashion. To study the effect of seasonality on the leading indicator analysis, we deseasonalize the data (using Winter's method and assuming a 3-month cycle), follow the leading indicator analysis as before, and then compare the forecast performance (MAPE) of the leading indicator identified this way. Table 4 shows the results of the comparison in reference to Table 2. The table list the difference in MAPE between the original and the deseasonalized results; negative numbers signify that the leading indicator identified after deseasonalization outperforms the original method.

TABLE 4
Comparing the Forecast Performance before and after
Deseasonalization (A negative number signifies that an
improvement is achieved by deseasonalization.)

| | MAPE | MAPE | MAPE | MAPE | MAPE | MAPE |
|---|---|---|---|---|---|---|
| Time | EP: 9-24 | VP: 25 | VP: 25, 26 | EP: 14-24 | VP: 25 | VP: 25, 26 |
| lag | (%) | (%) | (%) | (%) | (%) | (%) |
| 0 | −1.32 | −1.45 | 3.87 | −2.08 | 10.67 | 6.78 |
| 1 | −1.70 | 6.77 | 6.96 | −2.61 | 9.42 | 4.56 |
| 2 | −2.80 | −6.04 | −0.22 | −2.02 | −1.99 | −6.73 |
| 3 | −1.30 | 5.90 | 1.76 | −1.68 | 11.57 | 4.48 |
| 4 | −2.34 | 8.78 | 4.44 | −2.81 | 9.50 | 3.29 |
| 5 | −2.61 | 5.63 | 1.38 | −4.22 | 9.43 | 3.15 |
| 6 | −2.16 | 5.64 | 0.62 | −2.45 | 11.15 | 5.35 |
| 7 | −4.12 | 6.56 | −1.07 | −5.72 | 12.70 | 3.79 |

The results show that while deseasonalization results in better fit during the EP (as indicated by the negative numbers in the EP columns), it produces overall worse forecasting performance (as indicated by the mostly positive numbers in the VP columns). One possible reason is shown to be the difficulty in adjusting away the seasonal fluctuations without distorting the rest of information contained in the data. That is, seasonality adjustment might unintentionally remove important characteristics in the demand information that we are trying to capture with the leading indicator.

### Implications to Capacity Planning and Capacity Negotiation

The leading indicator engine not only provides a new perspective on demand forecasting, but that it also provides a tool to support capacity planning and capacity negotiation with supply partners. More specifically, the leading indicators provide a time-lagged model that predicts the demand pattern of a broader demand group. Suppose that the broader demand group is about to experience a shortage in the following quarter. If the capacity planners have this information ahead of time, then they can renegotiate capacity levels with the partner foundries. In this context, clustering products by technology or by manufacturing resources may make sense, since the predicted aggregate demand corresponds directly to future capacity requirements. Consider that a leading indicator for a certain technology group might suggest a demand surge a few months from now. While this prediction may be highly variable and unreliable at the individual product level, the prediction for the group as a whole tends to be more robust. Moreover, the strength of the prediction by the leading indicator is quantified by the coefficient of correlation and the fitting error (in MAPE), both of which provide a measure for the quality of the information.

While capacity configuration and allocation are important decisions for any manufacturing firm, a few factors make this problem especially crucial to semiconductor firms. The first factor is that there are high costs and long lead times associated with equipment procurement and clean room construction. Although a significant portion of the capacity is owned by outside foundries, state-of-the-art manufacturing equipment often costs millions of dollars and must be ordered months in advance. The clean rooms cost several hundred million dollars to a few billion dollars and take one to two years to construct. During a market upside, there may be a shortage of capacity, which means that the foundry will not be able to react to a sudden surge in demand. In this environment, an advanced signal of demand changes (e.g., from the leading indicator) is a significant advantage at the negotiation table. Specifically, if reliable demand information is available on aggregated technology groups, more favorable terms on capacity level may be negotiated a few months ahead of the competition. This could result in major savings in capacity costs, while avoiding detrimental capacity shortages during market upside.

A second factor that complicates capacity planning is the rapid advancement of fab technologies and the pace of transition from old technologies to new. Typically, fab technologies are defined by line width (the space between features on a semiconductor die) and wafer size. With each improvement in photolithography technology, new and more expensive equipment must be purchased so that features with smaller line widths can be produced. At the same time, wafer sizes are increasing, which increases the number of chips to be made at once and produces higher yields. This in turn reduces the unit cost of manufacturing. As semiconductor technologies improve, foundries must migrate their manufacturing capability to the newer technologies. However, they are cautious with decisions on technology transition; transitions take time, and they must be anticipated correctly. A premature transition could lead to costly underutilization of equipment or necessary production of older technologies on newer, more expensive equipment. A delayed transition could lead to missed market opportunities and a lower return on investment (ROI) for the capital investment. The leading indicator approach could play an important role here. For instance, a leading indicator for a particular technology group could provide advance notice on demand changes and thus signal the need for a technology migration. Since the technology migration is likely to involve contract negotiation with outside foundries, the advance notice provided by the leading indicator may shorten the lead time for a major technology migration, enabling more favorable terms with the foundry suppliers.

A third factor that complicates capacity planning is that actual execution of the capacity plan is subject to much uncertainty, requiring frequent adjustments and reconfigurations. The “effective capacity” required to manufacture the same technology may be different in each location, depending upon the technology mix (capacity configuration), the wafer sizes made at a facility, the skill level of the labor and myriad other factors. The leading indicator approach may play a significant role in capacity reconfiguration during execution. For instance, a certain number of wafer-starts (production units) are allocated for a particular product that requires a certain technology; suppose the leading indicator projects that the demand for this product will be postponed for a few months. In this case, an operations manager may decide to act on the leading indicator information and reallocate this capacity to a mature product requiring an older technology. This can be done since newer equipment typically can be used to manufacture older technologies, albeit at a lower cost efficiency. Nonetheless, it may be cost effective to reconfigure the capacity proactively rather than reacting to the demand changes later on. Similar to the previous situations, the leading indicator could provide significant advantage by providing earlier warnings of an undesirable situation.

The leading indicator engine provides a multi-purpose decision support tool that has significant implications to capacity planners, supply-demand planners and others. In addition to capacity planning and capacity negotiation, the leading indicator analysis has important implications to other planning functions such as financial forecasting and inventory forecasting. Exemplary applications of the leading indicator analysis according to embodiments of the invention are described below.

Financial Forecasting: The leading indicator approach could be a useful tool for projecting revenue and inventory for a fiscal period. In this context, a leading indicator could be used to drive and adjust revenue projections based on the trends of main revenue streams in the near future. For financially critical product groups, leading indicators could be developed to provide advanced notice of potential revenue short falls or new business opportunities. One major difference between capacity planning and revenue forecasting is the form of the data that drives the planning process. Capacity planning is concerned with expected unit volume requirements of specific resources, whereas revenue forecasting is concerned with estimated sales for a specific market segment, business entity or customer. To reflect this difference in the leading indicator approach, demand could be characterized in terms of sales rather than unit volume.

Inventory Forecasting: The goal of inventory forecasting is to project inventory cost and/or inventory velocity for a given future period. Inventory is perhaps one of the most difficult phenomena to project in the high-tech industry, because it is a product of many highly volatile factors, including sales, product mix, product cost, manufacturing yield, cycle time variation and supply volatility. As such, a methodology that can simplify the process of forecasting inventory would be very valuable. The leading indicators studied in this research are based on a characterization of “demand.” Since inventory is a phenomenon driven by more than just demand, the specific analysis in this research has limited applicability for predicting inventory. However a similar leading indicator analysis may be based on identifying leading indicators for inventory cost rather than demand and could be applied as a useable inventory model. Another approach that warrants consideration is to develop leading indicators for each of the factors that significantly influences inventory and combine these leading indicators to derive a leading indicator for inventory.

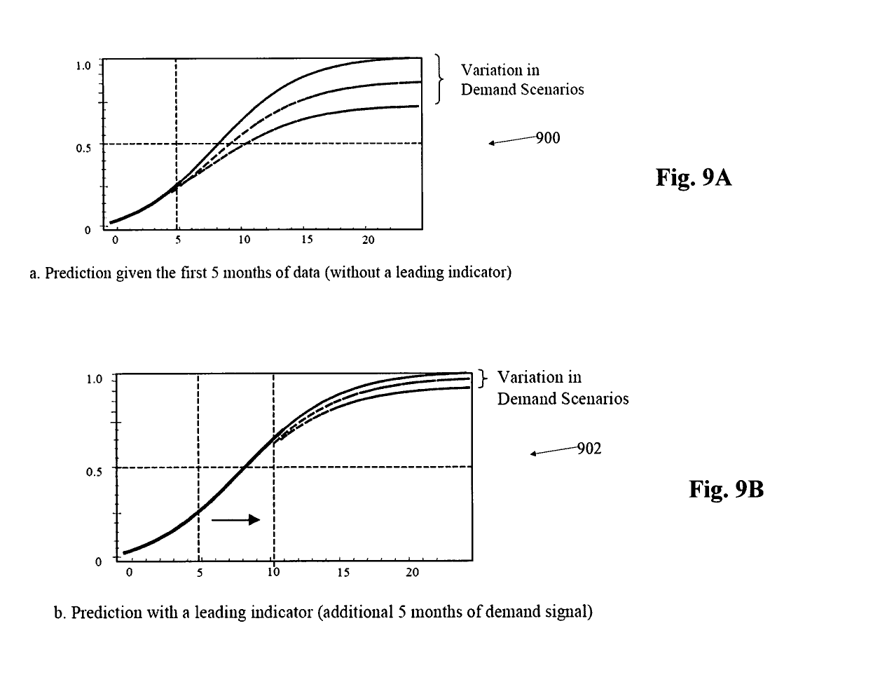

Predicting Demand Growth: An important realization concerning semiconductor products is that a particular product only goes through one lifecycle of growth, stability, and decline, i.e., a single modal lifecycle curve. Therefore, the cumulative demand of a product over its lifecycle can be expressed as an S-shaped function. The shape of this function specifies the precise pattern of demand growth over time. More specifically, the demand growth pattern can be characterized by the point of inflection of the S-shaped function, which represents the most drastic change. The leading indicator method according to exemplary embodiments of the invention described herein may be used to streamline the projection of demand growth patterns for a product group of interest as illustrated in FIGS. 9A-B.

For a product group of interest, it is possible to project probabilistically a number of different demand growth patterns from the current point in time to the end of the demand lifecycle. Such a projection is illustrated by the plot 900 in FIG. 9A. The variance associated with such projections, however, may be too high for the projection to be useful. Using the leading indicator method according to an exemplary embodiment of the invention, it is possible to reduce the variance of the projected demand growth patterns. This can be accomplished by monitoring the demand of the leading indicator product and using its advanced demand signal to (Bayesian) update the initial demand projection, thereby reducing its variance. As illustrated by the plot 902 in FIG. 9B, the reduction in variance can be significant; this is due to the fact that a small movement on the time axis might correspond to a drastic change on the demand curve, especially when the point of inflection is included in the movement.

Technology Substitutions: In the context of technology forecasting and demand characterization, an additional complication is the replacement effect demonstrated by subsequent generations of a technology. For example, at some time during the lifecycle of a particular chip designed for a cell phone model, a next-generation chip is in the process of being designed and developed, perhaps for a new cell phone model. The demands for the new product will begin to replace the demands for the old product during its lifecycle. As illustrated in FIG. 7, in reality, the migration of technology innovation over multiple generations may not be “clean-cut” and could include significant overlaps, driven by a complex replacement relationship (e.g., several existing chips maybe replaced by one new chip). The leading indicator analysis may be expanded to examine and incorporate the implications of technology substitution.

An exemplary method and apparatus described herein may be used to predict future data values based on the identification of “leading indicators” from past data values. Leading indicators are data items that are shown statistically to predict the pattern of a larger data set. The method shows that a leading indicator's pattern-predicting property is preserved in future data. The method monitors the unfolding of the leading indicator data over time, while making statistical influences of the future patterns of the larger data set. For example, the method could predict the surge in demand volume several months ahead of time, or predict a highly volatile or stable demand pattern for the months to come. Past data values such as past product demand values are received. Leading indicators are identified based on the past data values. The future data values are generated based on the leading indicators.

It is complemented that the invention described above may be implemented in software on microprocessors/general purpose computers (not shown). In an exemplary embodiment of the invention, the leading indicator engine is implemented in a spreadsheet-based program. In various embodiments, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention. The foregoing describes the invention in terms of embodiments foreseen by the inventors for which an enabling description was available, although insubstantial modifications of the invention, not presently foreseen may nonetheless represent equivalents thereto.

What is claimed is:

1. A method of identifying leading indicators comprising:
a. receiving a plurality of data streams;
b. selecting a cluster of the plurality of the received data streams;
c. determining a strength of a plurality of data streams of the cluster relative to at least a portion of the plurality of received data streams;
d. selecting at least one of the data streams having a strength exceeding a threshold value as a leading indicator.

2. The method of claim 1 where the strength of each data stream of the cluster is determined relative to the plurality of data streams excluding the data stream whose strength is being determined.

3. The method of claim 1 further comprising the step of repeating steps (b) and (c) for a different cluster of the plurality of the received data streams when the strength of the selected cluster does not exceed the threshold value.

4. The method of claim 1 where the strength of each data stream of the cluster is determined by computing a correlation between that data stream of the cluster subject to a time offset, and at least a portion of the plurality of received data streams.

5. The method of claim 1 where the strength of each data stream of the cluster is determined based on a correlation between data values of each data stream of the cluster subject to a time offset and at least a portion of the cluster of data streams.

6. The method of claim 1 wherein the plurality of received data streams are indexed by time.

7. The method of claim 1 wherein the data streams include demand information for a group of products and the method comprises identifying one or more products from the group of products as leading indicators for the group of products.

8. A method of generating predicted values of a plurality of data streams comprising:
a. identifying at least one leading indicator according to the method of claim 1; and
b. generating predicted values for at least one of the data streams based on the at least one of the data streams selected as leading indicators.

9. The method of claim 8 wherein the predicted values are generated by
regressing the plurality of data streams against the data streams of the at least one of the data streams selected as leading indicators to determine the corresponding regression parameters; and
generating a prediction for the plurality of data streams using a function defined by the regression parameters.

10. The method of claim 8 comprising generating first predicted values using a first prediction method and adapting the first prediction method in response to the leading indicators.

11. The method of claim 10 wherein the first prediction method is adapted to improve the accuracy of its prediction.

12. The method of claim 8 wherein the strength of the plurality of data streams of the cluster is determined from a portion of such data streams from an estimation period (EP) and the method comprises validating each such data stream having a strength exceeding a threshold value based on a portion of such data stream from a validation period (VP).

13. The method of claim 8 wherein the data streams include demand information corresponding to short life-cycle products and the generated predicted values provide demand forecast information for the short life-cycle products.

14. A method of generating a prediction comprising:
a. receiving a plurality of data streams;
b. determining a strength of one or more of the plurality of data streams;
c. identifying at least one of the one or more data streams having a strength greater than a threshold value as a leading indicator;
d. generating predicted values for the plurality of data streams based on the at least one of the one or more data streams identified as a leading indicator.

15. The method of claim 14 step b comprises determining the strength of at least one cluster of the plurality of data streams, step c comprises identifying a cluster having a strength greater than a threshold value as a leading indicator, and step d comprises generating predicted values based on the cluster.

16. The method of claim 14 comprising determining strength by generating a correlation between the one or more of the plurality of data streams subject to a time offset and the plurality of received data streams excluding the one or more of the plurality of data streams.

17. The method of claim 14 wherein at least one of the plurality of data streams comprises a composite data stream.

18. The method of claim 14 wherein the data streams correspond to one of capacity, inventory and finances and the method comprises performing capacity planning, inventory forecasting, and financial forecasting, respectively, based on the predicted values.

19. A method of generating a prediction comprising:
a. receiving a plurality of data streams;
b. computing a correlation between each of the plurality of data streams and the other of the plurality of data streams;
c. selecting data streams responsive to the strength of their respective computed correlation;
d. generating predicted values for at least one of the plurality of data streams based on the selected data streams.

20. The method of claim 19 wherein at least one of the plurality of data streams comprises a composite data stream.

21. The method of claim 19 wherein the predicted values are generated by:
regressing the plurality of data streams against the selected data streams to determine the corresponding regression parameters; and
generating a prediction for the plurality of data streams using a function defined by the regression parameters.

22. A computerized system for generating a prediction comprising:
a computerized database stored on a computer memory medium; and
a processor in communication with the database and configured to control the system to:
receive a plurality of data streams,
determine a strength of one or more of the plurality of data streams,
identify at least one of the one or more data streams having a strength greater than a threshold value as a leading indicator, and
generate predicted values for the plurality of data streams based on the at least one of the one or more data streams identified as a leading indicator.

23. The system of claim 21 wherein at least one of the plurality of data streams comprises a composite data stream.

24. The system of claim 21 wherein the processor is further configured to control the system to generate the predicted values by:
regressing the plurality of data streams against the selected data streams to determine the corresponding regression parameters; and
generating a prediction for the plurality of data streams using a function defined by the regression parameters.
